(19) United States
(12) Patent Application Publication
(10) Pub. No.: US 2005/0056001 A1
(43) Pub. Date: Mar. 17, 2005

(54) Power generation plant

(76) Inventors: Hans Ulrich Frutschi, Riniken (CH); Rolf Dittmann, Nussbaumen (CH)

Correspondence Address: CERMAK & KENEALY LLP, P.O. BOX 7518, ALEXANDRIA, VA, 22307, US

(21) Appl. No.: 10/936,576

(22) Filed: Sep. 9, 2004

Related U.S. Application Data
(63) Continuation of application No. PCT/EP03/50054, filed on Mar. 11, 2003.

(30) Foreign Application Priority Data
Mar. 14, 2002 (CH) 2002 0444/02

(51) Int. Cl. F02C 6/18

(52) U.S. Cl. 60/39.182

(57) ABSTRACT

In a power generation plant, for example a power station plant for the generation of electricity, a secondary machine (1a, 1b, 1c, 2) is connected downstream of an open-cycle gas turboset (100) for the utilization of the waste heat of the exhaust gases (107). The secondary machine is a machine working in a closed cycle with a gaseous process fluid, for example a closed-cycle gas turboset having a compressor (1a, 1b, 1c), a device for heating the compressed gas (6) which utilize the waste heat of the exhaust gas (107) of the primary gas turboset (100), a turbine (2) and at least one heat sink (13). In one embodiment, intercoolers (41, 42) are arranged during the compression process. A variable cycle charge of the secondary machine permits superior flexibility in the utilization of greatly varying supplies of waste heat available.

This application is a Continuation of, and claims priority under 35 U.S.C. § 120 to, International application number PCT/EP03/50054, filed 11 Mar. 2003, and claims priority under 35 U.S.C. § 119 to Swiss application number 2002 0444/02, filed 14 Mar. 2002, the entireties of both of which are incorporated by reference herein.

### BACKGROUND OF THE INVENTION

1. Field of the Invention

The present invention relates to a power generation plant, in particular a power station plant. It also relates to a method of operating a power station plant.

2. Brief Description of the Related Art

Power station plants in which a secondary machine is connected downstream of a gas turboset acting as primary machine in order to utilize the waste heat are already best known per se as combined cycle plants. In the most common embodiment, a heat-recovery steam generator is arranged in the exhaust-gas duct of a gas turboset, a steam quantity which is used to drive a steam turbine being generated in this heat-recovery steam generator. The extraction of process or heating steam is also possible. EP 924 410 discloses a power station plant in which a secondary open-cycle gas turboset is connected downstream of the primary gas turboset. Both types of construction have comparatively poor scaleability of the operation for different supplies of waste heat. In a downstream steam plant, for example, sufficient superheating of the live steam must always be provided for in order to avoid excessive wetness in the final stages of the steam turbine. The secondary steam cycle therefore cannot normally be operated below a minimum exhaust-gas temperature of the primary machine. In addition, large exhaust-steam flows and a large condenser are required on account of the normally low condenser pressure. A secondary gas turboset connected downstream as secondary machine can certainly handle the operation better with decreasing temperature level of the exhaust gas. However, if the supply of waste heat varies, for example on account of an adjustment of the inlet guide row of the primary machine, and the temperature level of the waste heat remains approximately constant, the case will also occur where the secondary machine is no longer able to reach the possible top process temperature. Thus the turbine inlet temperature of the secondary machine becomes lower than would be possible; consequently, the efficiency of the secondary gas turbine process drops. On account of the comparatively low temperature level overall, such effects will quickly become significant.

However, the most recent developments in the liberalized power markets require power station plants which can be operated in a highly flexible manner, have good operating characteristics and satisfactory efficiencies over a wide load range instead of optimized efficiencies only within a narrow load range. This is important in particular in weak networks, where only a few power station plants have to cope with all the network fluctuations, and where distinct part-load characteristics are in great demand. Such good part-load characteristics are also in great demand, inter alia, in applications for drives; consideration would be given here, in particular, to marine and locomotive drives.

### SUMMARY OF THE INVENTION

It is therefore an aspect of the present invention to specify a power generation plant of the type mentioned at the beginning which avoids the disadvantages of the prior art and in which, in particular, high flexibility in the utilization of the waste heat is provided for.

An aspect of the invention is therefore to arrange a machine working with a gaseous process fluid and having a physically completely closed fluid cycle as secondary machine. It is in this case well-understood that this process fluid—process gas—does not pass through any phase change during the entire cyclical process of the secondary machine. In the secondary machine, the gaseous process fluid is first of all compressed, then directed on the secondary side through the exhaust-gas heat exchanger of the primary gas turboset, where it absorbs heat, expands and is returned completely for compression, in which case, preferably before and/or during the compression, heat dissipation from the process fluid takes place in a heat sink. The conduction of the process fluid in a closed cycle offers surprising advantages especially for the utilization of the waste heat: firstly, the process fluid can be freely selected in order to obtain, for example, thermodynamic properties of the process fluid which are suitable in an especially effective manner for utilization at low temperatures. Furthermore, the mass flow of the circulating fluid can be changed by adapting the overall pressure level of the secondary process, as a result of which it is possible to react to a, for example, decreasing supply of waste heat at an essentially constant temperature, with an essentially uniform pressure ratio and thus with the secondary machine still at a good efficiency. In other words, it is thus possible, by simply varying the overall pressure level of the secondary process, by supply or discharge of circulating process fluid, to set the mass flow of the latter in such a way that the top process temperature of the secondary machine is close to the exhaust-gas temperature of the primary machine. Thus, in an exemplary operating mode of the power generation plant according to the invention, the cycle charge, thus the overall pressure level of the process, is regulated in such a way that the top process temperature of the secondary machine in steady-state operation is never more than 50° C., preferably 30° C., below the exhaust-gas temperature of the primary machine, and, in particular, this temperature difference, which is necessary in order to provide a temperature gradient driving the heat transfer, is adjusted within a range of 5° C. to 20° C.; in this case, the value which can be achieved also depends on the size of the heat transfer areas available. Furthermore, since no phase change of the process fluid takes place, operation at a low top process temperature is also possible without it being necessary, as described at the beginning, to pay attention to a minimum requisite live steam temperature of a two-phase process. It can readily be understood that superior flexibility in the utilization of the waste heat of a gas turboset is made possible by the invention.

The secondary machine is realized in particular by at least one driven machine being arranged for compressing the process fluid and by at least one prime mover being arranged for expanding the process fluid. In this case, at least one prime mover is arranged with at least one driven machine and/or a power consumer on a common shaft, possibly also with an interposed gear unit; single- or multi-shaft embodiments of the secondary machine are then obtained. The power consumer may be a generator for example; but consideration may also be given to a marine propeller, a drive wheel and the like. In this case, the prime mover driving the generator may also act on the generator of the primary gas turboset via an automatically acting clutch; this then results in principle in the construction of a single-shaft combined cycle plant known per se. Depending on the specific output to be realized, the driven machines and prime movers used are preferably fluid-flow machines, turbines and turbocompressors. In the case of small specific outputs/fluid volumetric flows, the use of displacement machines may also have advantages, or a cascading connection of turbomachines and displacement machines.

It has been mentioned above that a heat sink is also arranged in the secondary machine. Based on a gas turboset working in a closed cycle, the arrangement of the heat sink in the flow path from the turbine to the compressor is common. In an embodiment of the invention, at least one heat sink, for example an intercooler, is arranged in direct fluid connection to the means intended for compressing the process gas. Isothermal or quasi-isothermal compression can thus be achieved. Improved utilization of the waste heat is made possible by the reduced final compression temperature. In another exemplary embodiment of the invention, the heat sinks arranged in the compression path of the compression from the low pressure of the secondary process to the high pressure of the secondary process are regulated in such a way that the final compression temperature of the secondary machine is above the dew point temperature of the exhaust gases of the primary machine by a certain, but small, safety margin. For example, the final compression temperature can be adjusted to 70° C. to 75° C. for a gas-fired primary machine and to 130° to 150° C. for an oil-fired primary machine. For the best utilization of the waste heat, the final compression temperature is less than 20° C., preferably less than 2° C. to 10° C., above the dew point temperature of the exhaust gas of the primary machine.

In a further embodiment of the power generation plant according to the principles of the present invention, the secondary machine has a heat sink in the low-pressure part, in the flow path from the last prime mover to the first driven machine, this heat sink being designed as a heat-recovery steam generator. The steam generated there is introduced into the gaseous process fluid by suitable means at a pressure which is above the low pressure of the secondary machine, expands with said process fluid while delivering power and essentially condenses again in a heat sink at the low pressure. The condensate is then separated from the process fluid, is processed and is fed back again into the heat-recovery steam generator by suitable means, for example a feed pump. The cycle of this additional medium is also closed. The process gas flows with low residual moisture into the compression means again. Compared with a genuine two-phase process, substantially lower top process temperatures can be used: by means of the variation in the cycle charge described, the pressure ratios can be set in such a way that sufficient superheating of the live steam is always provided for. This embodiment with recuperation of the waste heat in the secondary machine is especially suitable in the case of low pressure ratios of the secondary machine. If this embodiment is combined with intercoolers in the compressor of the secondary machine, condensate separators are preferably provided there.

### BRIEF DESCRIPTION OF THE DRAWINGS

The invention is explained in more detail below with reference to exemplary embodiments illustrated in the drawing. In detail:

FIG. 1 shows a first power generation plant according to the invention;

FIG. 2 shows the changes of state in the power generation plant from FIG. 1 in the T-s diagram;

FIGS. 3 and 4 show further embodiments of power generation plants according to the invention.

In this case, the exemplary embodiments shown represent only a small instructive part of the invention characterized in the claims.

### DETAILED DESCRIPTION OF THE EXEMPLARY EMBODIMENTS

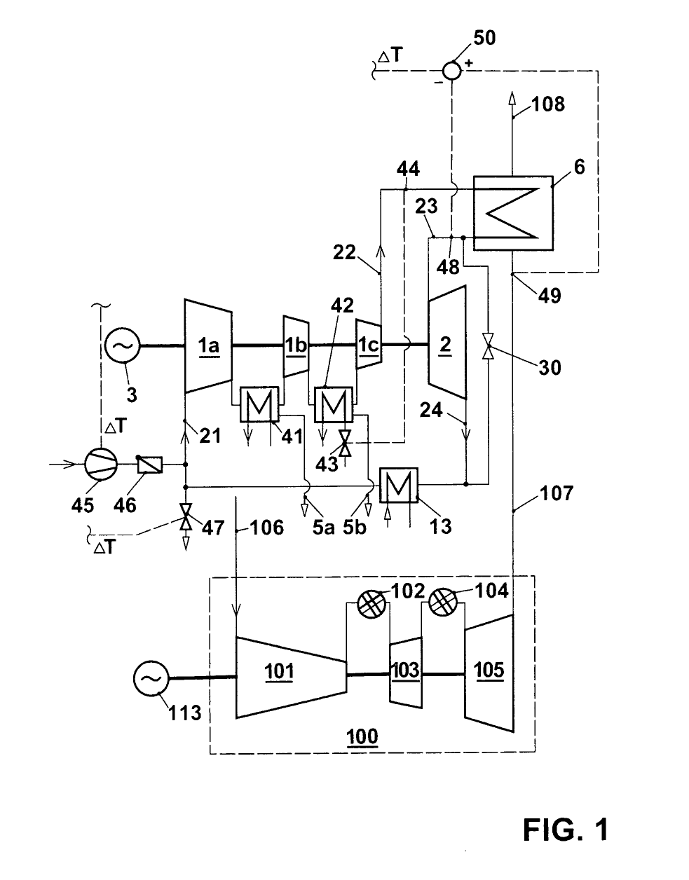

A power station plant according to the invention is shown in FIG. 1. As primary machine, a gas turboset 100 drives a generator 113. Without constituting a restriction, this gas turboset is one with sequential combustion, as is well known from EP 620 362 and numerous publications based thereon. Without going into details, its basic function is briefly explained. A compressor 101 and two turbines 103 and 105 are arranged on a common shaft. The compressor 101 draws in an air quantity 106 from the environment. Fuel is admixed with the compressed air in the first combustion chamber 102 and burned there. The flue gas is partly expanded in the first turbine 103, for example at a pressure ratio of 2. The flue gas, which still has a high residual oxygen content of typically over 15%, flows into a second combustion chamber 104, where further fuel is burned. This reheated flue gas is expanded in the second turbine 105 approximately at ambient pressure—apart from pressure losses of the exhaust gas duct—and flows off from the gas turboset as still hot exhaust gas 107 at temperatures which, at high load, are around 550-600° C. for example. Arranged in the flow path of the hot exhaust gas are means for utilizing the waste heat, heat exchanger 6, in which the exhaust gas is cooled down further, before it flows off as cooled exhaust gas 108 into the atmosphere. The heat exchanger 6, arranged as means for utilizing the waste heat, transfers heat from the exhaust gas 107 of the open-cycle gas turboset 100 to the circuit of a closed-cycle gas turboset arranged as secondary machine. A turbine 2 is arranged with compressor sections 1a, 1b, 1c and a generator 3 on a common shaft. The compressor consisting of a plurality of compressor sections 1a, 1b, 1c delivers a gas 21, in the present case air, from a low pressure upstream of the first compressor section 1a to a high pressure downstream of the last compressor section 1c. Arranged between the compressor sections are heat sinks, intercoolers 41 and 42, through which a cooling medium, for example cooling water, passes in counterflow. The intercooling reduces the power consumption of the compressor. In addition, the final compression temperature is reduced, which in the present case brings about further advantages explained below. The greater the number of intercoolers arranged between the compressor sections, the closer the compression process is to isothermal compression; there are, however, quite clear limits to this in practice. Furthermore, it is also known to use injection coolers, or to introduce liquid droplets into compressors, which provide for evaporation for continuous internal cooling. In the present case, in contrast thereto, the intercoolers 41 and 42 are provided with internal condensate separators 5a, 5b, the function of which will be explained below in connection with the compressor 45. The compressed process gas, high-pressure process gas 22, flows through the heat exchanger 6 in counterflow to the exhaust gas 107; the cooled exhaust gas 108 of the primary gas turboset flows off into the atmosphere. The heated high-pressure process gas 23 flows into the turbine 2 and drives the latter. In the event of a loss of load, the process gas can be shifted immediately to the low pressure side via a bypass element 30 while avoiding the turbine 2. The expanded process gas 24 flows through a heat sink, recooler 13, and finally flows into the compressor again as low-pressure process gas 21. The pressure of the low-pressure process gas 21 and of the expanded process gas 24, respectively, can be varied for regulating the output of the closed-cycle gas turboset. To increase the inlet pressure, a compressor 45, via a nonreturn element 46, delivers air to the low-pressure side of the closed-cycle gas turboset. To reduce the pressure, gas is blown off again into the atmosphere via a throttling or shutoff element 47. Air moisture is brought into the cycle when the latter is charged with ambient air via the compressor 45. This air moisture tends to condense in the intercoolers 41 and 42, for which reason condensate separators 5a, 5b are arranged in an integrated manner there. For the best utilization of the waste heat in the heat exchanger 6, the temperature of the high-pressure process gas 22 is as low as possible; however, the exhaust gas 107, 108 on the primary side of the heat exchanger must not drop below the dew point. A temperature measuring point 44 is therefore arranged downstream of the last compressor section Ic. Depending on the temperature measured there, action is taken at an adjusting element 43 which regulates the coolant mass flow to the last intercooler 42 in such a way that the temperature at the compressor outlet is above the dew point temperature of the exhaust gas of the primary machine by a certain safety margin. This ensures that, on the one hand, the output required for driving the compressor is minimized and that the waste heat of the exhaust gas 107 is utilized, so far as it can be utilized while avoiding the formation of deposits in the exhaust gas. A further control intervention to be advantageously implemented in the secondary cyclic process uses two temperature measuring points—temperature measuring point 49 for determining the temperature of the exhaust gas 107 before entering the heat exchanger 6 and temperature measuring point 48 for determining the temperature of the heated high-pressure process gas 23 of the closed-cycle gas turboset when issuing from the heat exchanger. Both measured values are directed to a subtractor former 50, where a temperature difference ΔT is formed. If this temperature difference exceeds a certain value, the throttling and shutoff element 47 is opened and the process pressure is reduced. Since the mass flow of the process gas of the secondary machine consequently drops, the compressed process gas is brought to a higher temperature, and the temperature difference becomes smaller. On the other hand, if the temperature difference drops below a lower limit value, the pressure level, in particular the pressure on the low-pressure side of the closed-cycle gas turboset connected as secondary machine, is increased via the compressor 45. The mass flow in the cycle of the secondary machine increases, and thus the temperature difference also increases again. Furthermore, the heated high-pressure process gas 23 alone can be regulated for temperature, in order to keep the latter constant at a desired value. A further control intervention in the lower process pressure would be to regulate the pressure ratio over the turbine 2 to a constant value, this pressure ratio naturally also being determined primarily by the volumetric inlet flow and thus being dependent on the mass flow and the inlet temperature and on the absolute pressure. It would also be conceivable to regulate the turbine outlet temperature of the secondary machine via the circulating mass flow. The combination of the regulating mechanisms described results in the best utilization of the waste heat potential. It is found that the adaptation of the secondary machine to greatly varying supplies of waste heat when using a secondary machine having a closed gas cycle is possible in a surprisingly simple and efficient manner by varying the low pressure and the mass flow circulating in the secondary machine.

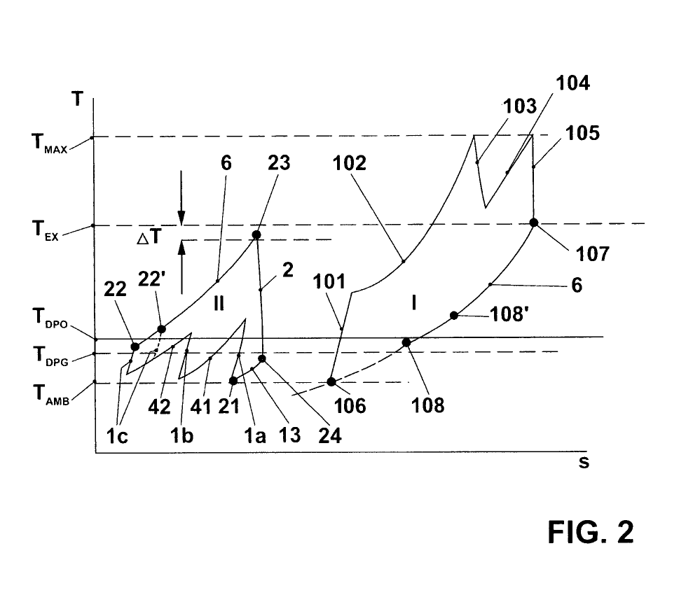

In the power station plant shown, the secondary machine is operated without waste-heat recuperation downstream of the turbine and with intercooling in the compressor ideally with a high design pressure ratio of preferably 10 and above. Thus, at a predetermined inlet temperature into the turbine 2, the outlet temperature from the turbine 2 and thus also the heat quantity to be dissipated in the recooler 13 can be kept low. The associated changes of state are shown in a highly schematic manner in the diagram in FIG. 2—temperature T plotted against mass-specific entropy s. The right-hand cycle, which is designated by I, is the cycle of the primary machine. The air 106 is drawn in at a temperature T_{AMB} and is compressed by the compressor 101. In the combustion chamber 102, heat is supplied approximately isobarically up to the maximum temperature T_{MAX}. The flue gas produced in the combustion chamber 102 is partly expanded in the turbine 103 and is interheated again in the combustion chamber 104 up to the maximum temperature before expansion to ambient pressure in the turbine 105. The hot exhaust gas 107 has the temperature T_{EX}. The secondary cyclic process II is shown to the left of the cyclic process I, since of course said secondary cyclic process II generally takes place at a pressure level above atmosphere. Its starting point is the process gas 21 upstream of the compressor, this process gas being essentially at ambient temperature and at the process low pressure. The process gas is compressed by a first compressor section 1a, in the course of which the temperature increases, and is then cooled down again in the intercooler 41 as far as possible to ambient temperature, is compressed further in a further compressor section 1b, is cooled down in a second intercooler 42 and is compressed in a last compressor section 1c to a state 22 or 22′, which is at the process high pressure. It can be seen that the greater the number of compressor sections and intercoolers, the more effectively is the compression brought closer to an isothermal compression. The cooling capacity in the last intercooler 42 is regulated in such a way that the final compression temperature of the state 22 or 22′ is slightly above the dew point temperature T_{DPG} for gas firing or T_{DPO} for oil firing. The lower the final compression temperature, the more effectively can the heat of the exhaust gas be utilized. On account of the intercooling stages, a high pressure ratio with the lowest possible final compression temperatures can also be achieved. In the heat exchanger 6, the compressed process gas 22 absorbs heat from the exhaust gas 107 and is heated to slightly below the exhaust-gas temperature. At the same time, the exhaust gas 107, when flowing through the heat exchanger 6, cools down to the state 108 or 108′, which, on account of the control of the final compression temperature of the secondary process, is above the respective dew point temperature by a small safety margin. The heated process gas 23 is expanded in the turbine 2 to the state 24. On account of the high pressure ratio, this temperature is comparatively low, so that only a little heat has to be dissipated in the recooler 13. In this design, the entire heat dissipation takes place at as low a temperature as possible, which helps to achieve a high efficiency. The possibilities considered for adapting the secondary machine to the supply of waste heat by varying the process low pressure have already been discussed above; the changes in the cyclic processes during part-load operation will be readily understood by the person skilled in the art.

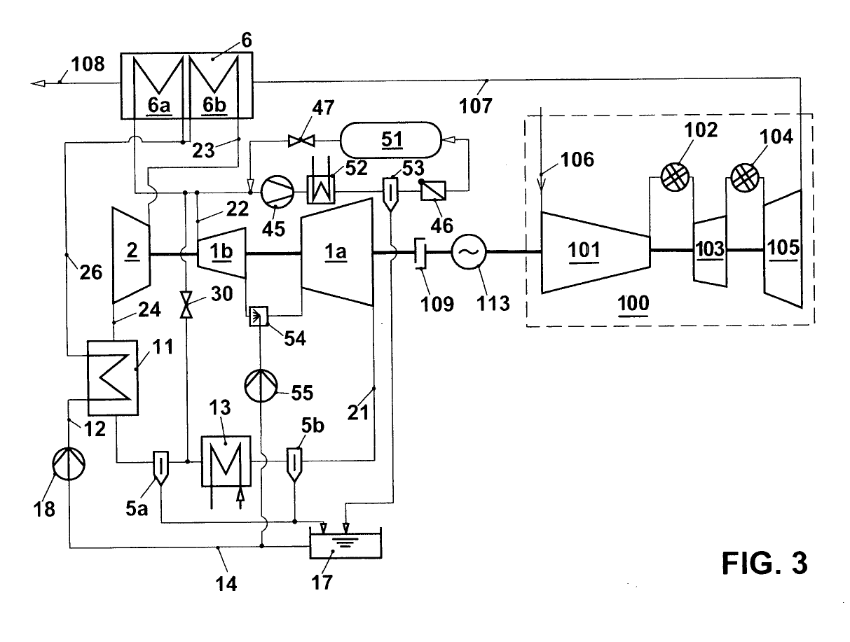

A further exemplary embodiment of the invention is shown in FIG. 3. A gas turboset 100 of the type of construction described above is again arranged as primary machine. A closed-cycle gas turboset with waste-heat recuperation is arranged as secondary machine and is described below. Since the exhaust-gas heat is utilized, the secondary machine shown here is operated with a lower pressure ratio than the closed-cycle gas turboset shown in connection with FIG. 1; a typical pressure ratio would be within the range of 4 to 10, in particular 6 to 8. Furthermore, the secondary machine as shown is suitable for being operated with a process gas other than air. The low-pressure process gas 21 of the secondary machine is compressed to a high pressure in a first compressor section 1a and a second compressor section 1b, between which an injection cooler 54 is arranged as intercooler. The injection cooler 54 may readily also be designed in such a way that it overmoistens the process gas; water droplets then penetrate into the following compressor stages and provide for internal cooling there. In this respect, a corresponding injection device may also already be arranged upstream of the first compressor section. On account of the lower pressure ratio, complicated further cooler stages can be dispensed with. Nonetheless, it is advantageously ensured that the temperature of the high-pressure process gas is above the dew point temperature of the exhaust gases 107, 108 of the primary gas turboset. The high-pressure process gas flows through the heat exchanger 6, subdivided into two heat exchanger sections 6a, 6b, in counterflow to the exhaust gases before the heated high-pressure process gas flows through a turbine 2 while performing work. The turbine 2 is arranged with the compressor sections 1a and 1b on a common shaft and drives the latter; furthermore, the output of the turbine can be transmitted via an automatically acting clutch 109 to a common generator 113 of primary and secondary machines. Expanded process gas 24 is brought back again to the initial state of the low-pressure process gas 21 in a heat sink designed as a heat-recovery steam generator 11 and in a recooler 13. Feedwater 12 under pressure flows through the heat-recovery steam generator on the secondary side—this may also involve a liquid other than water, in particular also toxic liquids, since all the media are conducted in the closed cycle. The liquid under pressure is heated and evaporated in the heat-recovery steam generator and the steam generated is at least slightly superheated. At a point of the exhaust-gas heat exchanger 6 which is adapted in terms of temperature and at which the steam temperature is below the exhaust-gas temperature, the live steam 26 is introduced into the process gas and flows together with the latter through the second heat exchanger section 6b. The steam flows together with the process gas through the turbine with power being delivered. Furthermore, this steam, including a steam quantity which results from the liquid feed to the injection cooler 54, flows on the primary side through the heat-recovery steam generator 11, is cooled down in the process and condenses. In this case, the condensation temperature depends on the partial pressure, in accordance with the dew point of the steam in the process gas. Further steam is condensed in the recooler 13. Condensate is separated from the process gas in the condensate separators 5a and 5b and collected in a vessel 17. From there, the condensate is on the one hand delivered via a pump 55 to the injection cooler 54 and in particular is delivered again as feedwater 12 to the secondary side of the steam generator 11 by a feed pump 18. The secondary machine is provided with a system for varying the cycle charge and thus for varying the process pressure level. A compressor 45 can draw off some of the high-pressure process fluid 22 from the cycle and deliver it via a cooler 52, a separator 53 and a nonreturn element 46 into a high-pressure gas accumulator 51. By the displacement of process fluid from the cycle into the gas accumulator 51, the charge of the cycle with circulating process fluid and thus the overall process pressure level are reduced. If required, the fluid quantity stored in the gas accumulator 51 can be fed back again into the cycle via the shutoff and throttle element 47, as a result of which the cycle charge and the pressure level increase again. As described, this variation in the cycle charge is suitable in an especially effective manner for the permanent output control of the secondary machine.

Furthermore, the energy stored in the high-pressure gas accumulator can be made available especially quickly as useful output power, since the pressurized gas acts virtually directly on the turbine during discharge of the high-pressure gas accumulator. This spontaneous increase in output can be used especially advantageously for the frequency back-up control of an electrical network. The most varied accumulator systems are known from the prior art, including, for example, accumulators with cascading pressure. The cycle charge and thus the pressure level of the secondary machine can be regulated in accordance with the criteria discussed in connection with FIG. 1, and furthermore in such a way that certain superheating of the steam at the turbine inlet is achieved.

Of course, principles of the present invention can also be realized if a plurality of primary machines act on a common secondary machine via a common heat exchanger; as has already been mentioned several times, the secondary machine of the power station plant according to the invention is especially suitable for reacting to a fluctuating supply of waste heat by the operation of a varying number of primary machines.

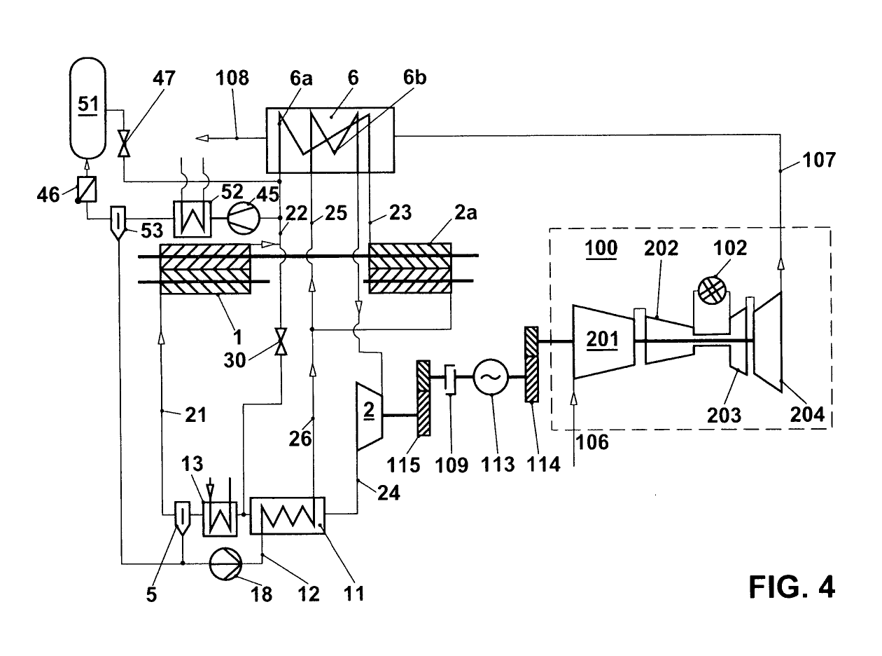

In order to illustrate that the invention is in no way restricted to the use of turbomachines for carrying out the secondary process, FIG. 4 shows an embodiment of the power station plant according to the invention which can be realized in an especially effective manner for small specific outputs in combination with an industrial gas turbine or an “aeroderivative” as primary machine. The gas turboset 100 shown is a twin-shaft machine, having a high-pressure compressor 202 and a high-pressure turbine 203 on a common shaft and a low-pressure compressor and a low-pressure turbine on a second common shaft, which serves as output shaft for the useful output, and a combustion chamber. Such gas turbosets of small outputs normally run at a speed which is well above the network frequency. The output shaft therefore acts on the generator 113 via a reduction gear unit 114. The functioning of the primary machine 100 is readily apparent in the light of the above comments. According to the invention, the waste heat of the hot expanded flue gas 107 is transferred in a heat exchanger to a secondary machine working with a gaseous process fluid in a closed cycle and is utilized there. On account of the small mass flow and volumetric flow of the secondary machine, a displacement machine, screw-type compressor 1, is used instead of a turbocompressor for the compression of the process gas from low-pressure process gas 21 to high-pressure process gas 22. The high-pressure process gas 22 flows through a heat exchanger 6a and absorbs heat from the exhaust gas 107. The heated high-pressure process gas 23 flows into a first prime mover designed as displacement machine, screw-type expander 2a, and is expanded there to an intermediate pressure. The screw-type expander 2 drives the screw-type compressor 1. The intermediate-pressure process gas 25 together with a live steam quantity 26 fed from a heat-recovery steam generator 11 flows through a second heat exchanger section 6b and is interheated. The now larger volumes require larger cross sections of flow, for which reason a turbine, in particular a radial-flow turbine, is selected for the expansion of the intermediate-pressure process gas and of the steam to the low pressure. This turbine likewise drives the generator 113 via a second reduction gear unit 115 and an automatically acting clutch 109. In the heat-recovery steam generator 11 and in the recooler 13, the expanded process gas 24 is brought back again to the initial state 21, and the steam is condensed, and the condensate is separated from the process gas in the condensate separator 5 and is delivered again as feedwater 12 to the heat-recovery steam generator 11 by a feed pump 18. Furthermore, the secondary machine has rapid shutdown means, in particular a bypass line with a bypass element 30. A high-pressure-process-gas accumulator 51 is likewise arranged together with the already sufficiently described charging and discharging means. Of course, the completely closed cycle of the secondary machine permits a free choice in principle of suitable process fluids, both as process gas and for the steam generation.

In all the embodiments shown, instead of a generator, another power consumer, in particular a mechanical drive, could also be arranged. Here, inter alia, consideration could be given to a marine propeller.

List of designations
1 Compression means, displacement machine, screw-type compressor
1a, 1b, 1c Compression means, compressor section
2 Expansion means, turbine
2a Expansion means, displacement machine, screw-type expander
3 Power consumer, generator
5 Condensate separator
5a, 5b Condensate separator
6 Heat exchanger
6a, 6b Heat exchanger, heat exchanger section
11 Heat sink, heat-recovery steam generator
12 Feedwater mass flow
13 Heat sink, cooler
17 Vessel, condensate reservoir
18 Feed pump
21 Low-pressure process gas
22 Compressed process gas, high-pressure process gas
23 Heated high-pressure process gas
24 Expanded process gas
25 Intermediate-pressure process gas
26 Live steam
30 Bypass element
41 Intercooler
42 Intercooler
43 Adjusting element
44 Temperature measuring point
45 Compressor
46 Nonreturn element
47 Throttling and shutoff element
48 Temperature measuring point
49 Temperature measuring point
50 Subtractor
51 High-pressure-process-gas accumulator
52 Cooler
53 Condensate separator
54 Injection cooler
55 Pump
100 Gas turboset
101 Compressor
102 Combustion chamber
103 Turbine
104 Combustion chamber
105 Turbine
106 Air quantity
107 Exhaust gas
108 Cooled exhaust gas
109 Clutch
113 Power consumer, generator
114 Reduction gear unit
115 Reduction gear unit
201 Low-pressure compressor
202 High-pressure compressor
203 High-pressure turbine
204 Low-pressure turbine
ΔT Temperature difference
T_{AMB} Ambient temperature
T_{EX} Turbine outlet temperature
T_{DPG} Dew point temperature, gas operation
T_{DPO} Dew point temperature, oil operation
T_{MAX} Maximum temperature

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

1. A power generation plant, comprising:
a primary engine and a secondary engine connected downstream of said primary engine in a throughflow direction of the primary engine for the utilization of waste heat;
the primary engine comprising
an open-cycle gas turbo set including at least one compressor,
at least one combustion chamber, and
at least one turbine including a most downstream turbine;
a heat exchanger arranged downstream of the most downstream turbine of the primary engine for transferring heat from the exhaust gas of the primary engine to the process fluid of the secondary machine;
the secondary engine comprising
at least one driven machine for compressing a gaseous process fluid from a first low pressure to a second high pressure,
means for feeding the compressed process fluid to the heat exchanger,
at least one power engine, arranged downstream of the heat exchanger for expanding the process fluid from the high pressure to the low pressure while performing work, and
at least one heat sink for heat dissipation from the process fluid;
wherein the fluid cycle of the secondary machine is fluidly completely closed.

2. The power generation plant as claimed in claim 1, further comprising:
a common shaft; and
wherein at least one power engine of the secondary engine is arranged on the common shaft with one selected from the group consisting of at least one driven machine, a driven load, and both.

3. The power generation plant as claimed in claim 1, wherein the at least one power engine comprises a turbine.

4. The power generation plant as claimed in claim 1, wherein said at least one driven machine comprises a turbocompressor.

5. The power generation plant as claimed in claim 1, wherein at least one of said at least one heat sink is configured and arranged for cooling the process fluid during the compression from the low pressure to the high pressure.

6. The power generation plant as claimed in claim 1, wherein the secondary engine comprises a low-pressure part, said at least one power engine comprises a most downstream power engine, and further comprising:
a heat sink comprising a heat-recovery steam generator arranged downstream of the most downstream power engine in the low-pressure part of the secondary engine.

7. The power generation plant as claimed in claim 6, wherein the secondary engine comprises:
means for introducing steam generated in the heat-recovery steam generator at a pressure above the low pressure into the gaseous process fluid such that the steam flows through one selected from the group consisting of at least part of the power engines and a part of a power engine, and steam condenses in the low-pressure part of the secondary engine in at least one heat sink, and further comprising:
means for separating the condensate from the process fluid; and
means for increasing the pressure of the condensate separated by said means for separating and returning said condensate to the heat-recovery steam generator.

8. The power generation plant as claimed in claim 1, further comprising:
a device configured and arranged to vary pressure of the low pressure section; and
wherein the low-pressure section of the secondary machine is operatively connected with said device.

9. A method of operating a power generation plant, the method comprising:
providing a power generation plant as claimed in claim 5; and
controlling the heat sinks such that the temperature process fluid of the secondary engine after compression is above the dew point temperature of the exhaust gases of the primary engine.

10. The method as claimed in claim 9, comprising:
controlling the heats sinks such that the temperature of the process fluid of the secondary engine after compression is less than 20° C. above the dew point temperature of the exhaust gases of the primary engine.

11. The method as claimed in claim 9, comprising:
controlling the heats sinks such that the temperature of the process fluid of the secondary engine after compression is between 2° C. and 10° C. above the dew point temperature of the exhaust gases of the primary engine.

12. A method of operating a power generation plant, the method comprising:
providing a power plant as claimed in claim 8; and
adapting the secondary machine to different available waste-heat outputs, including varying the circulating mass flow of gaseous process fluid.

13. The method as claimed in claim 12, comprising:
adjusting the circulating mass flow such that the turbine inlet temperature of the secondary engine is less than 50° C. below the temperature of the exhaust gases issuing from the primary engine.

14. The power generation plant as claimed in claim 1, comprising an electric power generation plant.
